(19) United States
(12) Patent Application Publication
(10) Pub. No.: US 2025/0109838 A1
(43) Pub. Date: Apr. 3, 2025

(54) Endcap with Detritus Collection Troughs

(71) Applicant: Elemental LED, Inc., Reno, NV (US)

(72) Inventors: Nathan A. Davey, Reno, NV (US); Robert Green, Reno, NV (US)

(21) Appl. No.: 18/747,319

(22) Filed: Jun. 18, 2024

Related U.S. Application Data
(60) Provisional application No. 63/586,796, filed on Sep. 29, 2023.

(51) Int. Cl. F21V 15/015; F21S 4/28; F21Y 113/00; F21Y 115/10

(52) U.S. Cl. CPC F21V 15/015; F21S 4/28; F21Y 2113/00; F21Y 2115/10

(57) ABSTRACT

An endcap, e.g. for a linear luminaire. The endcap has projecting structure attached to and projecting from an inner surface thereof. The projecting structure defines at least two positions aligned with and spaced from one another along the inner surface. One or more crush ribs are connected to the projecting structure at each of the at least two positions. A trough is recessed into the inner surface of the endcap and surrounds at least a portion of each of the at least two positions. The trough provides space to receive any material that is separated from the one or more crush ribs when the endcap is inserted into a channel.

### CROSS-REFERENCE TO RELATED APPLICATIONS

This application claims priority to U.S. Provisional Patent Application No. 63/586,796, filed Sep. 29, 2023, the contents of which are incorporated by reference herein in their entirety.

### TECHNICAL FIELD

The invention relates to closures for linear luminaires, and in particular, to an endcap with detritus collection troughs.

### BACKGROUND

A linear luminaire is long, typically narrow, light-emitting device that uses light-emitting diodes (LEDs). In a linear luminaire, one or more strips of linear lighting provide light. Each strip of linear lighting is a printed circuit board (PCB) with LED light engines mounted at a regular pitch or spacing. The PCB may be rigid or flexible, and individual strips of linear lighting may be connected together to form a light-emitting strip of essentially any length.

Linear luminaires may take many forms, and may be used for general lighting, task lighting, accent lighting, and many other types of lighting. In its most basic form, a linear luminaire comprises a channel in which one or more strips of linear lighting are placed. The channel typically includes a cover to close the top of the channel and endcaps to seal the ends of the channel. U.S. Pat. Nos. D996,655 and D996,656 provide examples of the basic form of a linear luminaire. Numerous variations are possible in the shape of the channel, the shape and features of the cover, and the general features of the linear luminaire. For example, U.S. Pat. No. 11,199,300 provides a survey of the various functional features that may be included in one type of linear luminaire, and U.S. Pat. No. 11,054,091 shows various examples of optical systems that can be integrated into the cover of a channel to shape and focus the light emitted by a linear luminaire.

The channels and covers of linear luminaires are often extruded components, i.e., plastic or metal with the same cross-sectional shape over their lengths. For example, anodized aluminum channel and plastic cover material may be manufactured in 8-foot (2.4 m) lengths. During the manufacture of a linear luminaire, those components are often cut to a desired length. While the process may vary slightly depending on the features of the luminaire, at some point after installation of linear lighting in the channel, the ends of the channel/cover combination are sealed with endcaps. The endcaps are secured in the channel by a frictional or interference fit, which may be augmented by adhesives in some cases. The endcaps themselves may include ribs to improve the fit between channel and endcap.

### BRIEF SUMMARY

One aspect of the invention relates to an endcap. The endcap comprises a body, which has an outer surface and an inner surface opposite the outer surface. Projecting structure is attached to and projects from the inner surface of the body. The projecting structure defines at least two positions aligned with and spaced apart from one another along the inner surface of the endcap body. One or more crush ribs are connected to the projecting structure at each of the at least two positions. A trough recessed into the inner surface of the body surrounds at least a portion of the at least two positions. In that position, the trough provides room for any material that is separated from the crush ribs during the process of inserting the endcap into a structure, so that the separated material does not prevent the endcap from seating properly.

Another aspect of the invention relates to a linear luminaire. The linear luminaire comprises a channel, a strip of linear lighting disposed in the channel, a cover, and a pair of endcaps. Each of the pair of endcaps has the features described above.

In some embodiments, the projecting structure may take the form of two separate posts, spaced apart from one another along the inner surface of the body of the endcap. Each post may have one or more crush ribs. Those crush ribs may face laterally outward, such that the posts and the crush ribs engage the inner edges and sidewalls of a channel.

In other embodiments, the projecting structure may take the form of a plurality of members arranged in a shape, such as an H-shape, extending from the inner surface of the endcap. The projecting structure may have crush ribs, e.g., on laterally-facing outward edges thereof, or it may include or be associated with other structures, like posts, that include the crush ribs.

Other aspects, features, and advantages of the invention will be set forth in the description that follows.

### BRIEF DESCRIPTION OF THE DRAWING FIGURES

The invention will be described with respect to the following drawing figures, in which like numerals represent like features throughout the description, and in which:

FIG. 1 is a perspective view of a linear luminaire having endcaps with detritus collection troughs;

FIG. 2 is a partially exploded perspective view of the linear luminaire of FIG. 1;

FIG. 3 is a perspective view of one of the endcaps of the linear luminaire in isolation, with its interior-facing side shown, particularly illustrating a pair of troughs recessed into the interior surface of the endcap;

FIGS. 4-6 are a series of longitudinal cross-sections of the end of the channel of the linear luminaire and one of the endcaps, taken through Line 4-4 of FIG. 2, illustrating the process of inserting the endcap into the channel;

FIG. 7 is a cross-sectional view similar to the view of FIG. 6, albeit using an endcap that does not have a pair of troughs;

FIG. 8 is a perspective view of an endcap according to another embodiment; and

FIG. 9 is a perspective view of an endcap according to yet another embodiment.

### DETAILED DESCRIPTION

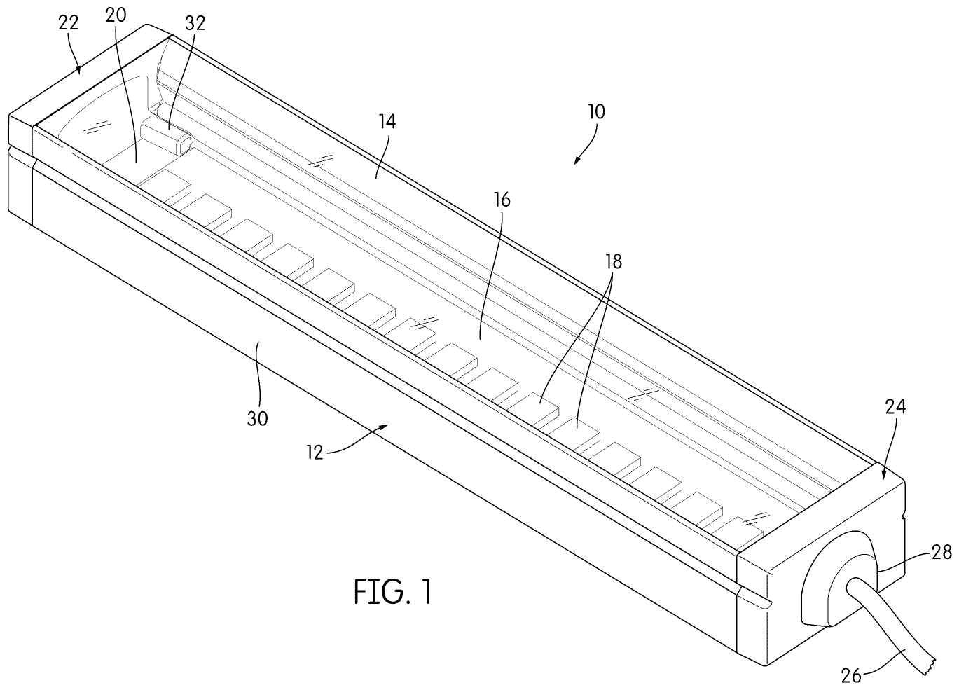

FIG. 1 is a perspective view of a linear luminaire, generally indicated at 10. The linear luminaire 10 comprises a channel 12 and a cover 14 covering the channel. A strip of linear lighting 16 with LED light engines 18 spaced at a regular pitch is disposed in the channel 12, in this case, on the bottom 20 of the channel 12. A pair of endcaps 22, 24 cap the ends of the channel 12 to close it. A power cable 26 transits through an opening in one endcap 24. That endcap 24 is associated with a strain relief fitting 28 that fits into the opening in the endcap 24.

The details of the strip of linear lighting 16, the LED light engines 18, and their function are not critical to the invention. The LED light engines 18 may emit light of a single color, or light of several colors. Much of this description will assume that the strip of linear lighting 16 accepts low-voltage, direct-current (DC) power. (In this description, the term “low voltage” will be used to mean voltages under 50V.) In some embodiments, the strip of linear lighting 16 may accept high-voltage DC or alternating-current (AC) power, although if the strip of linear lighting 16 accepts high voltage, it may have a slightly different form with more electrical insulation.

In a typical luminaire 10 of this type, the cover 14 has engaging structure along its sides that allows it to “snap” into place by engaging complementary engaging structure along the sidewalls 30 of the channel 12. (This structure is not shown in FIG. 1.) The endcaps 22, 24, by contrast, are designed simply to slide into the channel 12, engaging it with a tight or interference fit.

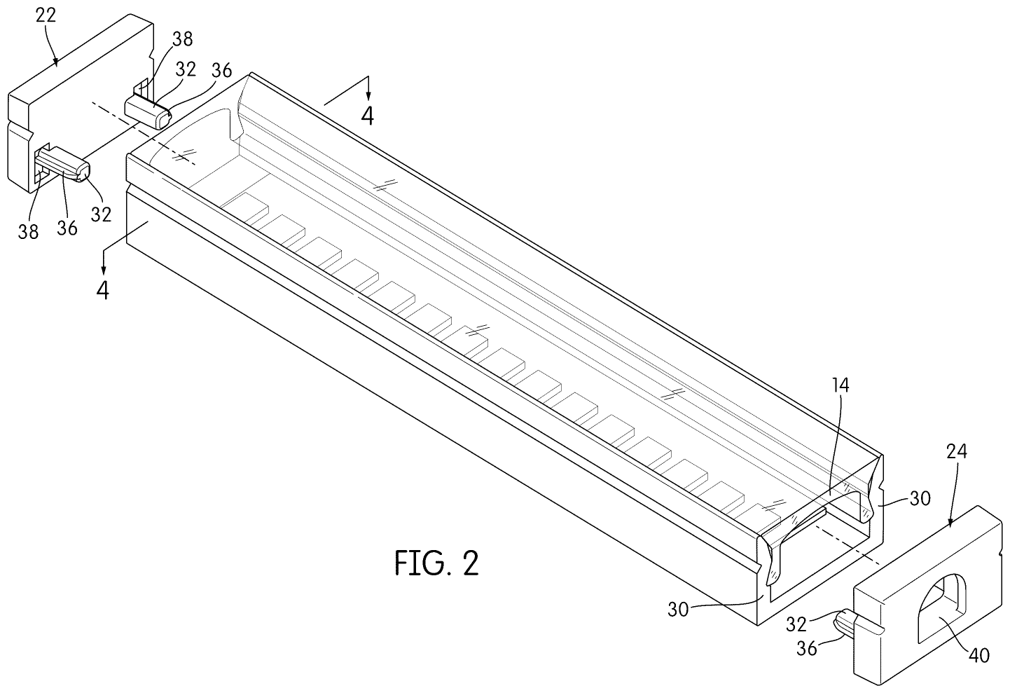

To facilitate the interference fit, each of the endcaps 22, 24 has a pair of posts 32. These pairs of posts 32 are better seen in the partially exploded perspective view of FIG. 2. The pair of posts 32 on each endcap 22, 24 extends perpendicular to the interior surface of the endcap 22, 24, projecting into the channel 12 in the views of FIGS. 1 and 2. The pair of posts 32 have dimensions and are set at a distance or spacing apart such that they form a tight or interference fit with the inner sidewalls 30 of the channel 12 to retain the endcaps 22, 24 in the channel 12.

The vertical position of the pair of posts 32 is not critical in creating the tight or interference fit between the sidewalls 30 and the endcaps 22, 24. However, for various practical reasons, such as preventing the pair of posts 32 from creating shadows, the pair of posts 32 are usually placed at a vertical position where the bottoms of the posts 32 will be at or just above the bottom 20 of the channel 12. In producing a linear luminaire 10, if the parts are mis-dimensioned or the mechanical fit of the endcaps 22, 24 is not sufficient, the pair of posts 32 may be secured to the bottom 20 of the channel 12 with adhesive.

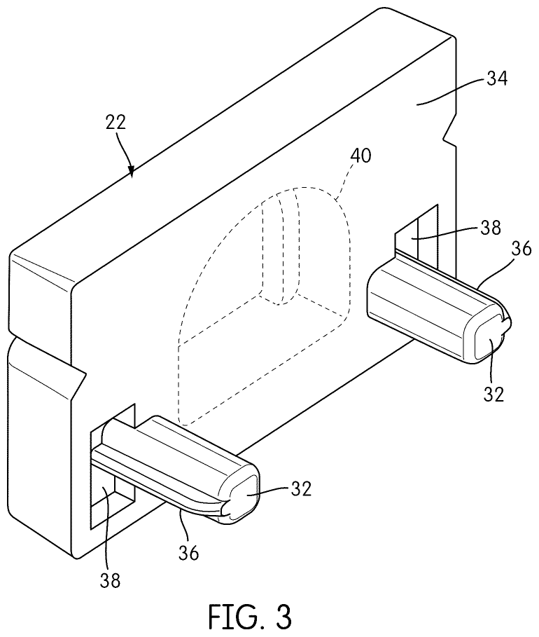

FIG. 3 is a perspective view of one of the endcaps 22, 24 in isolation, showing in particular its interior-facing surface 34. The endcaps 22, 24 differ only in the presence or absence of an opening, generally indicated at 40, which accommodates the power cable 26 and strain relief fitting 28. (The power cable 26 and strain relief fitting 28 have been removed in the partially-exploded view of FIG. 2.) As the presence or absence of the opening 40 is not critical to the remainder of the description, the opening 40 is indicated in broken lines in FIG. 3, and the endcap shown in FIG. 3 and the remaining figures will be referred to as endcap 22.

Each of the pair of posts 32 has the general shape of a rectangular prism with rounded corners and edges. (In the illustrated embodiment, each of the pair of posts 32 is essentially a square post with rounded corners and edges.) On the outward lateral aspect of each post 32, there is a raised, tapering crush rib 36 that is thinner than the post 32 itself, projects laterally outward from the outward face of each of the posts 32, and increases in width (i.e., height away from the body of the post 32) gradually from the tip of the post 32 toward the interior-facing surface 34 of the endcap 22, reaching its maximum extent toward the base of the post 32. The crush ribs 36 facilitate the tight fit of the endcap 22 in the channel 12, as will be described below in more detail.

As is also shown in FIG. 3, at least the outward lateral aspect of the base of each post 32 is seated in a trough 38 that is recessed into the interior-facing surface of the endcap 22. The trough 38 is substantially greater in width and height than the post 32 and covers an area around each post 32. Specifically, the trough 38 covers the area of the post 32 around the crush ribs 36.

As was described above, channels 12 are often cut to a desired size in the process of manufacturing a linear luminaire 10. The cutting process may leave sharp edges at the cut ends of the channel 12. Even when the channel 12 is not cut during manufacturing, its end edges may still be sharp, and it may not be possible or desirable to grind, machine, or de-burr those edges, as doing so may damage any coating on the channel or make it impossible for an endcap 22 to seat properly against the end face of the channel 12.

Endcaps 22 are typically made of a material that is relatively soft, like a plastic. The present inventor has surprisingly found that when an endcap 22 is inserted into a channel 12, any sharp edges at the ends of the channel 12, may shave or slice into the crush ribs 36. The loose shavings or slices may then fold or twist in a way that prevents the endcaps 22 from seating properly in the channel 12.

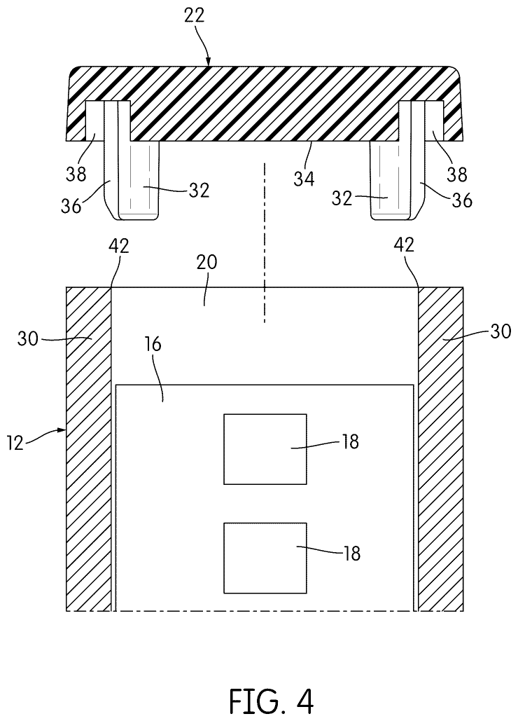

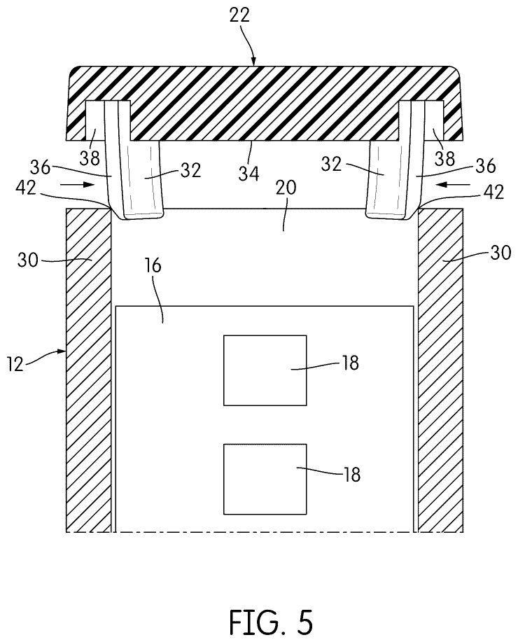

This is illustrated in the views of FIGS. 4-6, which are successive longitudinal cross-sectional views illustrating the end of the channel 12 and an endcap 22. In FIG. 4, the endcap 22 is brought close to the end of the channel 12 and aligned properly for insertion. As shown in FIG. 5, the pair of posts 32 makes contact with the channel 12 first as the endcap 22 is first brought into engagement with the channel. At this point, there is contact between interior end edges 42 of the sidewalls 30 and the respective crush ribs 36 of the pair of posts 32. The taper of the crush ribs 36 helps to cause a slight inward deflection of the pair of posts 32, forcing the pair of posts 32 between the sidewalls 30 and into the interior of the channel 12. As this happens, the interior end edges 42 of the sidewalls 30 may also shave or slice into the crush ribs 36.

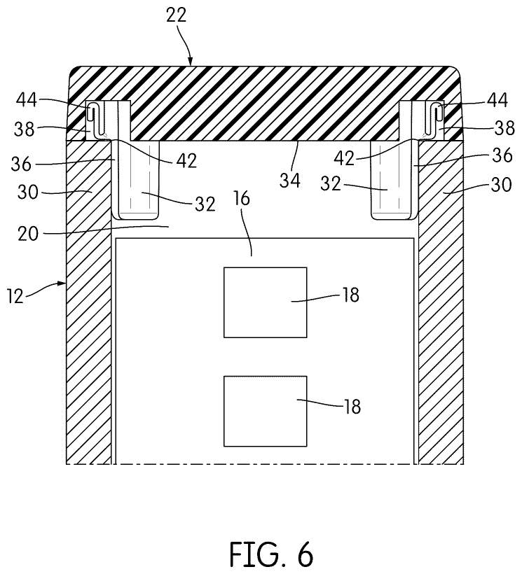

FIG. 6 shows the end result of the insertion process, and also illustrates the function and advantage of the troughs 38. In the view of FIG. 6, the interior end edges 42 of the sidewalls 30 have sliced into the crush ribs 36, separating but not fully detaching ribbons of material 44. This material 44 is bent back by the advancing motion of the pair of posts 32 against the interior end edges 42. The troughs 38 are positioned to provide space for the partially separated material 44.

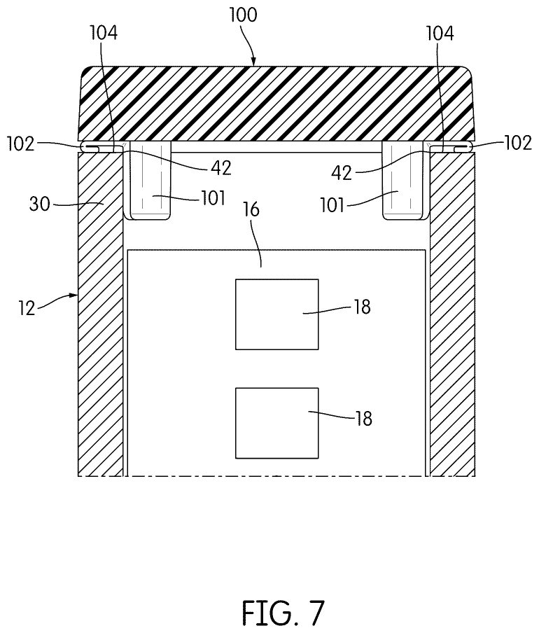

Contrast FIG. 6 with FIG. 7, a view similar to FIG. 6, yet with an endcap 100 that does not include troughs 38. Endcap 100 is otherwise identical to the endcap 22 of FIG. 6 and has the same issue as that of endcap 22—the interior end edges 42 of the channel 12 slice into the posts 101, leaving ribbons of partially separated material 102. However, with no specific place to go in endcap 100, that partially separated material 102 collects at the end face 104 of the channel 12, preventing the endcap 100 from seating properly against the end of the channel 12. The resulting gaps are unsightly, could allow dirt and moisture to enter the channel 12, and could make it easier to unseat the endcap 100 entirely.

Of course, FIGS. 6 and 7 illustrate only two possible scenarios. The manner in which the crush ribs 36 interact with the interior end edges 42 of the sidewalls 30, the material that results from that interaction, and the displacement and final position of that material may all vary from embodiment to embodiment and case to case. Whatever the final result, the troughs 38 provide more space to keep material from interfering with the fit of the endcaps 22.

The dimensions of the troughs 38 will depend on the dimensions of the posts 32, the dimensions of the endcap 22, and other such factors. In one embodiment, if the posts 32 have a total projecting length of 4 mm and a side length of 1.75 mm, the troughs 38 may have widths of 1.8 mm by 3.5 mm and depths of 0.8 mm. These dimensions may vary from embodiment to embodiment. In general, the troughs 38 may be of any dimensions, so long as the troughs 38 are not so large or so deep that they compromise the mechanical structure of the endcaps 22 or cause mold sink during the manufacturing process. The endcap 22 will typically be made of a plastic, such as acrylonitrile-styrene-butadiene (ABS), nylon, poly (vinyl chloride), etc.

In general, endcaps according to embodiments of the invention will follow the shapes of the channels whose ends they are configured to close. This means that numerous variations in shape, proportions, and other features are possible. Variations in the shape and proportions of the troughs and ribs are possible as well.

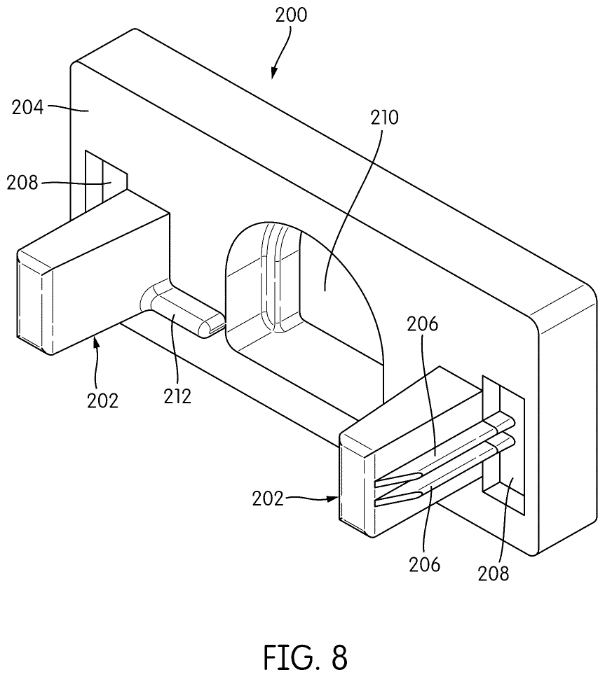

FIG. 8 is a perspective view of an endcap, generally indicated at 200, according to another embodiment of the invention. The endcap 200 is shorter than the endcap 22 described above, made to fit a channel of different dimensions. The basic configuration, though, is similar to that of the endcap 22 described above: a pair of posts 202 projects outward from the inward-facing surface 204 of the endcap 200. Each post 202 is more rectangular than its counterpart 32 in the endcap 22 described above, and each post 202 has a pair of individual crush ribs 206 on the outward-facing side of the post 202 that will interface with the edges and sidewalls of the channel (the crush ribs 206 of only one of the posts 202 are visible in the view of FIG. 8; the other side is a mirror image). The individual crush ribs 206 are tapered or chamfered, such that they increase in height gradually as one moves back from the front face of the post 202, until they reach a constant height.

The endcap 200 also has a pair of troughs 208. In keeping with the taller, narrower proportions of the posts 202, the troughs 208 are taller and narrower than the troughs 38 described above. However, the depth of the troughs 208 is essentially unchanged relative to the troughs 38 described above.

The endcap 200 is depicted with an opening 210 for a power cord and a strain relief fitting, although for the reasons explained above, an endcap without those features would otherwise be identical to the endcap 200. Additionally, in order to promote greater stability and mechanical strength, each post 202 is attached to a raised rib 212 that extends laterally some distance across the inner face 204 of the endcap 200.

In both endcaps 22, 200 described above, there is one pair of posts 32, 202, each post 32 supporting some number of crush ribs. This arrangement is most suitable when the channel in question has but a single compartment to be closed. The endcaps 22, 200 are also most suitable for channels that have entirely rectilinear shapes. However, a channel may have more than one compartment, and the linear luminaire need not be entirely rectilinear in shape.

As one example, U.S. Pat. No. 11,168,852, the contents of which are incorporated by reference herein in their entirety, discloses a channel with an H-shaped cross-section, defining upper and lower compartments. With this arrangement, the strip of linear lighting 16 typically goes in the upper compartment, while the lower compartment is used as a raceway for wiring and as a point of attachment for mounting brackets and other such hardware. An endcap may attach to such a channel by a tight or interference fit with the top compartment, the bottom compartment, or both. One advantage of a bottom-compartment mounting is that the mounting structure of the endcap does not interfere with the placement of the strip of linear lighting 16.

Another example is given in U.S. Pat. No. 11,054,091, the contents of which are also incorporated by reference herein in their entirety. In this patent, the channel in question has an upper compartment and a much smaller slot below the upper compartment that can be used for mounting. Moreover, the channel of the '091 patent is provided with an optical system including an outer lens that rises above the channel to a peak.

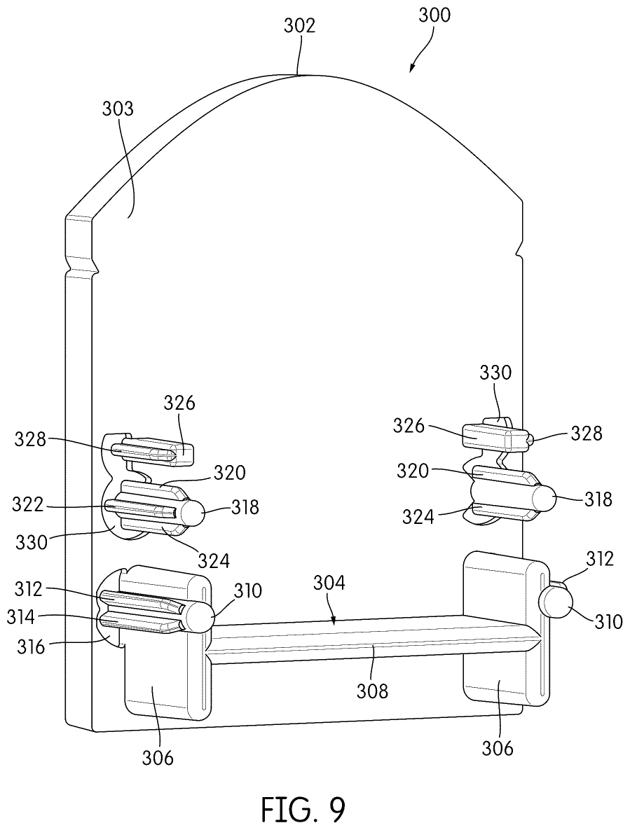

FIG. 9 is a perspective view of an endcap, generally indicated at 300, that is intended for use with more complex types of channels. The endcap 300 is of the sort that might be used with a channel having upper and lower compartments. As shown, the endcap 300 has a rectilinear shape on most of its sides but rises to a peak 302 at the top. Thus, this endcap 300 may be used to close a channel that has a lens system like that of the '091 patent.

In the embodiments described above, posts 32, 202 are the primary mechanical structures that provide for a tight or interference fit between the channel 30 and the endcap 22, 200. Those posts 32, 202 support crush ribs 36, 206 that ensure the desired fit. The endcap 300 uses a mix of structures, some of them more complex than in the embodiments described above.

More specifically, projecting outward from a lower portion of the inward-facing surface 303 of the endcap 300 is a H-shaped structure 304 with two mutually parallel bars 306 that extend parallel to the respective sides of the endcap 300, and a bar 308 that extends across the width of the endcap 300, perpendicular to the two parallel bars 306, connecting the two bars 306. A structure like this may have more mechanical rigidity than a lone post. Each of the bars 306 is integral with a post 310. Each post 310 has two laterally-projecting crush ribs 312, 314. The crush ribs 312, 314 are both vertically and angularly offset from one another. Both crush ribs 312, 314 are tapered or chamfered in the front, reaching a constant thickness toward the inward-facing surface 303 of the endcap 300.

The structure 304 with its integral posts 310 and crush ribs 312, 314 may, for example, insert into the lower compartment of a channel. Because of the increased rigidity of the structure 304 as compared with individual posts, the structure 304 is less likely to break as a result of insertion. However, like the embodiments described above, the endcap 300 is built assuming that some portion of the ribs 312, 314 may be sliced off by sharp edges during the insertion process. Thus, the endcap 300 has a trough 316 recessed into the inward-facing surface 303 around each post 310 that surrounds the base of the post 310. In this embodiment, each trough 316 is roughly semi-circular, drawing inward slightly between the two ribs 312, 314.

In addition to the structure 304, the endcap 300 has two sets of projecting posts spaced vertically above the structure 304. In a first set of projecting posts 318 above the structure 304, the posts 318 are each smaller in diameter than the posts 310 and are slightly set back from the position of the posts 310. Each post 318 has three crush ribs 320, 322, 324 angularly offset from one another by 90° around the post 318. The second set of projecting posts 326 is spaced vertically above the posts 318 and is set back from the sides of the endcap 300 farther than the lower posts 318. This second set of projecting posts 326 is rectangular in shape. Each of these rectangular projecting posts 326 has a single crush rib 328 that extends laterally outward.

Each upper set of posts 318, 326 shares a single, common trough 330 with a compound shape. The trough 330 covers three-quarters of a circle around the post 318 and flows into a roughly rectangular shape with a curved edge around the crush rib 328 of the rectangular post 326.

In the above description, the endcap 22, 200 engages with the sidewalls of a channel, like channel 30. The endcap 300 of FIG. 9 illustrates that an endcap according to an embodiment of the invention may engage with any available surface to fit into a channel. In particular, the structure 304 and its associated posts 310 and crush ribs 312, 314 may, e.g., be inserted into a lower compartment of a two-compartment channel. The intermediate posts 318 could be used to bear against both the sidewall of the channel and, e.g., a web or member that separates the two compartments of the channel. The uppermost posts 326 may engage with either the sidewalls of the upper compartment or, in some cases, with other fixed structures within the upper compartment.

As the configuration of the troughs 330 illustrates, a trough may have any shape or volume that is reasonably likely to accommodate material removed from the various crush ribs 320, 322, 324, 328 it serves.

While the invention has been described with respect to certain embodiments, the description is intended to be exemplary, rather than limiting. Modifications and changes may be made within the scope of the invention, which is defined by the appended claims.

What is claimed is:

1. An endcap, comprising:
a body having an outer surface and an inner surface opposite the outer surface;
projecting structure attached to and projecting from the inner surface of the body, the projecting structure defining at least two positions aligned with and spaced apart from one another along the inner surface;
one or more crush ribs connected to the projecting structure at each of the at least two positions; and
a trough recessed into the inner surface of the body and surrounding at least a portion of each of the at least two positions.

2. The endcap of claim 1, wherein the projecting structure comprises a pair of posts, each of the pair of posts disposed at one of the at least two positions, and each of the pair of posts having at least one of the one or more crush ribs projecting therefrom.

3. The endcap of claim 2, wherein each of the one or more crush ribs faces a lateral edge of the body.

4. The endcap of claim 3, wherein the trough comprises two separate troughs, each of the two separate troughs surrounding at least the portion of each of the at least two positions.

5. The endcap of claim 4, wherein each of the two separate troughs surrounds an outward lateral portion of each of the pair of posts.

6. The endcap of claim 1, wherein the projecting structure comprises a plurality of ribs.

7. The endcap of claim 6, wherein the projecting structure further comprises a pair of posts integral or connected to opposite lateral ends of the plurality of ribs.

8. The endcap of claim 7, wherein each of the pair of posts comprises at least one crush rib.

9. The endcap of claim 7, wherein the trough comprises two separate troughs, each of the two separate troughs surrounding at least the portion of each of the at least two positions.

10. A linear luminaire, comprising:
a channel;
a strip of linear lighting disposed in the channel;
a cover; and
a pair of endcaps, each of the pair of endcaps having
a body having an outer surface and an inner surface opposite the outer surface,
projecting structure attached to and projecting from the inner surface of the body, the projecting structure defining at least two positions aligned with and spaced apart from one another along the inner surface,
one or more crush ribs connected to the projecting structure at each of the at least two positions, and
a trough recessed into the inner surface of the body and surrounding at least a portion of each of the at least two positions.

11. The linear luminaire of claim 1, wherein one of the pair of endcaps further comprises:
an opening; and
a strain relief fitting positioned in the opening.

12. The linear luminaire of claim 10, wherein the projecting structure comprises a pair of posts, each of the pair of posts disposed at one of the at least two positions, and each of the pair of posts having at least one of the one or more crush ribs projecting therefrom.

13. The linear luminaire of claim 12, wherein each of the one or more crush ribs faces a lateral edge of the body.

14. The linear luminaire of claim 13, wherein the trough comprises two separate troughs, each of the two separate troughs surrounding at least the portion of each of the at least two positions.

15. The linear luminaire of claim 14, wherein each of the two separate troughs surrounds an outward lateral portion of each of the pair of posts.

16. The linear luminaire of claim 15, wherein the projecting structure comprises a plurality of ribs.

17. The endcap of claim 16, wherein the projecting structure further comprises a pair of posts integral or connected to opposite lateral ends of the plurality of ribs.

18. The endcap of claim 17, wherein each of the pair of posts comprises at least one crush rib.

19. The endcap of claim 17, wherein the trough comprises two separate troughs, each of the two separate troughs surrounding at least the portion of each of the at least two positions.
